(19) United States
(12) Patent Application Publication
(10) Pub. No.: US 2017/0273488 A1
(43) Pub. Date: Sep. 28, 2017

(54) DRINKING VESSEL WITH ILLUMINATION AND DRINK SENSING

(71) Applicant: Justin Michael Lonis, Mentor, OH (US)

(72) Inventor: Justin Michael Lonis, Mentor, OH (US)

(21) Appl. No.: 15/466,290

(22) Filed: Mar. 22, 2017

Related U.S. Application Data
(60) Provisional application No. 62/311,539, filed on Mar. 22, 2016.

(51) Int. Cl. A47G 23/16; G01C 19/5776; G08C 17/02; G08B 5/36; G08B 21/18; A47G 19/22; G01C 19/5783

(52) U.S. Cl. CPC A47G 23/16; A47G 19/2227; G01C 19/5776; G01C 19/5783; G08B 5/36; G08B 21/182; G08C 17/02; A47G 2019/2238; A47G 2019/2244

(57) ABSTRACT

A drinking vessel or container equipped with a mechanism or module configured to determine the number of drinking events during a drinking session is provided. The drinking vessel includes an orientation sensor configured to determine an orientation of the drinking vessel, a visual indicator operatively coupled to the drinking vessel, and a controller that is configured to receive signals from the orientation sensor. The controller is configured to determine whether the sensed orientation is indicative of a drinking event and provide a control signal to the visual indicator representative of the number of sensed drinking events during a given period.

### CROSS-REFERENCE TO RELATED APPLICATIONS

This application claims benefit of U.S. Provisional Patent Application Ser. No. 62/311,539, filed Mar. 22, 2016, and entitled “DRINKING VESSEL WITH ILLUMINATION AND DRINK SENSING”, which is herein incorporated by reference in its entirety.

### FIELD OF THE INVENTION

The disclosed technology relates generally drinking vessels, and, more particularly, drinking vessels with illumination and drink sensing.

### BACKGROUND OF THE INVENTION

Shot glasses have existed for years. The traditional primary use of a shot glass has been for a user to consume a pre-defined amount of alcohol, for example, 1.0 ounces to 1.5 ounces. Some conventional shot glasses have been configured to be illuminated for novelty purposes.

### SUMMARY OF THE INVENTION

A drinking vessel or container equipped with a mechanism or module configured to determine the number of drinking events during a drinking session is provided. The drinking vessel includes an orientation sensor configured to determine an orientation of the drinking vessel, a visual indicator operatively coupled to the drinking vessel, and a controller that is configured to receive signals from the orientation sensor, determine whether the sensed orientation is indicative of a drinking event and provide a control signal to the visual indicator representative of the number of sensed drinking events during a given period.

The drinking vessel can be configured to include a wireless communication interface operatively coupled to the controller, wherein the wireless communication interface is configured to wirelessly transfer signals representative of the number of sensed events to a portable communication device.

One aspect of the disclosed technology relates to a drinking vessel that includes a body having a closed bottom portion and a sidewall extending from the closed bottom portion and forming an open top portion; a base disposed below the body; an orientation sensor operatively coupled to the drinking vessel and configured to determine an orientation of the drinking vessel; a visual indicator operatively coupled to the drinking vessel; and a controller operatively coupled to the orientation sensor and the visual indicator. The controller is configured to receive signals from the orientation sensor indicative of a sensed orientation of the drinking vessel and determine whether the sensed orientation is greater than a predefined threshold. If the sensed orientation is greater than a predefined threshold, increment a counter indicative of the number of sensed events; and provide a control signal to the visual indicator representative of the number of sensed events.

According to one feature, the base is coupled to the bottom portion of the body.

According to one feature, the base is integrally formed with the bottom portion of the body.

According to one feature, the visual indicator is disposed within a portion of the base.

According to one feature, the visual indicator is positioned within the base such that the visual indicator can be viewed through a bottom portion of the base.

According to one feature, the visual indicator is positioned within the base such that the visual indicator can be viewed from above the drinking vessel.

According to one feature, the visual indicator is disposed within a portion of the sidewall of the body.

According to one feature, the sidewall of the body defines a space and the visual indicator is disposed within a portion of the space defined by the sidewall of the body.

According to one feature, a portion of the base defines a space and the visual indicator is disposed within a portion of the space defined by the base.

According to one feature, the visual indicator is a light emitting diode indicator.

According to one feature, the visual indicator is an alphanumeric indicator.

According to one feature, the alphanumeric indicator is controllable to display a number indicative of the number of counted drinking events.

According to one feature, the visual indicator is a non-alphanumeric indicator.

According to one feature, the visual indicator includes an electronically segmented rim associated with the upper portion of the sidewall.

According to one feature, the visual indicator includes an electronically segmented rim associated with a lower portion of the base.

According to one feature, the light emitting diode indicator is controllable to blink indicative of the number of sensed events/counted drinking events.

According to one feature, the drinking vessel is configured as a shot glass.

According to one feature, the orientation sensor is a gyroscope.

According to one feature, the drinking vessel includes a power supply operatively coupled to the controller, the orientation sensor and the visual indicator.

According to one feature, the power supply is a battery.

According to one feature, the drinking vessel includes a power switch.

According to one feature, the power switch is disposed in the base.

According to one feature, the drinking vessel includes a wireless communication interface operatively coupled to the controller, wherein the wireless communication interface is configured to wirelessly transfer signals representative of the number of sensed events to a portable communication device.

According to one feature, the wireless communication interface is a Bluetooth module.

Another aspect of the disclosed technology relates to a method of determining a number of drinking events during a drinking session using a drinking vessel. The drinking vessel includes a body having a closed bottom portion and a sidewall extending from the closed bottom portion and forming an open top portion, a base disposed below the body, an orientation sensor operatively coupled to the drinking vessel and configured to determine an orientation of the drinking vessel, and a visual indicator operatively coupled to the drinking vessel. The method includes receiving an input indicative of a user starting a drinking session; receiving signals from the orientation sensor indicative of a sensed orientation of the drinking vessel; determining that a drinking event occurred based on the signals received from the orientation sensor; incrementing a counter representative of a number of drinking events during the drinking session; and providing a visual representation on the drinking vessel representative of the number of drinking events detected during the drinking session.

According to one feature, the method includes wirelessly transmitting the number of drinking events during the drinking session to a portable communication device via a wireless transmitter.

According to one feature, determining that a drinking event occurred includes measuring an orientation of the drinking vessel and determining when a change in the orientation of the drinking vessel exceeds a predetermined threshold.

According to one feature, receiving an input includes detecting user actuation of a power switch operatively coupled to the drinking vessel.

According to one feature, the receiving an input includes receiving an input indicative or the user starting a drinking session having a predetermined time period.

According to one feature, the method includes providing a notification to the user indicative of an expiration of the predetermined time period.

According to one feature, providing a notification includes providing a notification via the visual indicator.

According to one feature, the providing a notification includes providing a notification via an audio device operatively coupled to the drinking vessel.

According to one feature, providing a notification includes wirelessly transmitting a signal via the wireless transmitter to a portable communication device.

According to one feature, providing a visual indication via the visual indicator representative of detecting a predefined maximum number of drinking events during the drinking session.

Another aspect of the disclosed technology relates to a drinking vessel that includes a body having a closed bottom portion and a sidewall extending from the closed bottom portion and forming an open top portion; a base disposed below the body; a sensor configuration operatively coupled to the drinking vessel; a visual indicator operatively coupled to the drinking vessel; a controller operatively coupled to the sensor configuration and the visual indicator The controller is configured to receive signals from the sensor configuration indicative of a sensed condition of the drinking vessel; determine whether the signals received from the sensor configuration are indicative of a drinking event; if the signals received from the sensor configuration are indicative of a drinking event, increment a counter indicative of the number of sensed drinking events; and provide a control signal to the visual indicator to display a visual indication representative of the number of sensed drinking events.

According to one feature, the sensor configuration includes an orientation sensor, wherein the orientation sensor is configured to sense the orientation of the drinking vessel.

According to one feature, the sensor configuration includes a motion sensor, wherein the motion sensor is configured to sense the motion of the drinking vessel.

According to one feature, the sensor configuration includes a weight sensor, wherein the weight sensor is configured to sense the weight of liquid contained by the drinking vessel.

According to one feature, the sensor configuration includes a liquid sensor, wherein the liquid sensor is configured to detect the presence of liquid within the drinking vessel.

Another aspect of the disclosed technology relates to a shot glass that includes a body defining a volume for receiving a liquid; a sensor configuration operatively coupled to the shot glass; a visual indicator operatively coupled to the shot glass; a controller operatively coupled to the sensor configuration and the visual indicator. The controller is configured to receive signals from the sensor configuration indicative of a sensed condition of the shot glass; determine whether the signals received from the sensor configuration are indicative of a shot of liquid being consumed from the shot glass; if the signals received from the sensor configuration are indicative of a shot of liquid being consumed from the shot glass, increment a counter indicative of the number of shots being consumed from the shot glass; and provide a control signal to the visual indicator to display a visual indication representative of the number of shots being consumed from the shot glass.

These and further features of the disclosed technology will be apparent with reference to the following description and attached drawings. In the description and drawings, particular embodiments or aspects of the disclosed technology have been disclosed in detail as being indicative of some of the ways in which the principles of the disclosed technology may be employed, but it is understood that the disclosed technology is not limited correspondingly in scope. Rather, the disclosed technology includes all changes, modifications and equivalents coming within the spirit and terms of the claims appended thereto.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF SEVERAL VIEWS OF THE DRAWINGS

These and other features of the disclosed technology, and their advantages, are illustrated specifically in embodiments of the disclosed technology now to be described, by way of example, with reference to the accompanying diagrammatic drawings, in which:

FIG. 1 is a diagrammatic illustration of a drinking vessel in accordance with one exemplary aspect of the disclosed technology;

FIG. 2 is a diagrammatic illustration of a drinking vessel in accordance with one exemplary aspect of the disclosed technology;

FIG. 3 is a diagrammatic illustration of a drinking vessel in accordance with one exemplary aspect of the disclosed technology;

FIG. 4 is a diagrammatic illustration of a drinking vessel in accordance with one exemplary aspect of the disclosed technology;

FIG. 5 is a diagrammatic illustration of a drinking vessel in accordance with one exemplary aspect of the disclosed technology;

FIG. 6 is a diagrammatic illustration of a drinking vessel in accordance with one exemplary aspect of the disclosed technology;

FIG. 7 is a diagrammatic illustration of a drinking vessel in accordance with one exemplary aspect of the disclosed technology;

FIG. 8 is a diagrammatic illustration of a drinking vessel with a visual indicator in accordance with one exemplary aspect of the disclosed technology;

FIG. 9 is a diagrammatic illustration of a drinking vessel with a visual indicator in accordance with one exemplary aspect of the disclosed technology;

FIG. 10 is a diagrammatic illustration of a drinking vessel with a visual indicator in accordance with one exemplary aspect of the disclosed technology;

FIG. 11 is a diagrammatic illustration of a stability-assessing system including exemplary sensors in accordance with one aspect of the disclosed technology;

FIG. 12 is a diagrammatic illustration of a stability-assessing system including exemplary sensors in accordance with one aspect of the disclosed technology;

FIG. 13 is a diagrammatic illustration of a stability-assessing system including exemplary sensors in accordance with one aspect of the disclosed technology;

FIG. 14 is a functional block diagram of a drinking vessel in wireless communication with a mobile device in accordance with one aspect of the disclosed technology;

FIG. 15 is a circuit schematic for a drinking vessel controller and sensor in accordance with one exemplary aspect of the disclosed technology;

FIG. 16 is a flow diagram of an operational method of determining a number of drinking events during a drinking session using a drinking vessel in accordance with one aspect of the disclosed technology;

FIG. 17 is a flow diagram of an operational method of determining a number of drinking events during a drinking session using a drinking vessel in accordance with one aspect of the disclosed technology;

FIG. 18 is a flow diagram of an operational method of determining a number of drinking events during a drinking session using a drinking vessel in accordance with one aspect of the disclosed technology;

FIG. 19 is a flow diagram of an operational method of determining a number of drinking events during a drinking session using a drinking vessel in accordance with one aspect of the disclosed technology;

FIG. 20 is a flow diagram of an operational method of determining a number of drinking events during a drinking session using a drinking vessel in accordance with one aspect of the disclosed technology;

FIG. 21 is a diagrammatic illustration of a drinking vessel in wireless communication with a mobile device in accordance with one aspect of the disclosed technology;

FIG. 22 is a flow diagram of an operational method of determining a number of drinking events during a drinking session using a drinking vessel in accordance with one aspect of the disclosed technology.

It should be noted that all the drawings are diagrammatic and not drawn to scale. Relative dimensions and proportions of parts of these figures have been shown exaggerated or reduced in size for the sake of clarity and convenience in the drawings. The same reference numbers are generally used to refer to corresponding or similar features in the different embodiments. Accordingly, the drawing(s) and description are to be regarded as illustrative in nature and not as restrictive.

### DETAILED DESCRIPTION OF EMBODIMENTS

A drinking vessel or container equipped with a mechanism or module configured to determine the number of drinking events during a drinking session is provided. The drinking vessel includes an orientation sensor configured to determine an orientation of the drinking vessel, a visual indicator operatively coupled to the drinking vessel, and a controller that is configured to receive signals from the orientation sensor, determine whether the sensed orientation is indicative of a drinking event and provide a control signal to the visual indicator representative of the number of sensed drinking events during a given period.

As is described in more detail below, the drinking vessel or container can take one a number of configurations without departing from the scope of the disclosed technology. In accordance with a preferred embodiment, the drinking vessel or container (also simply referred to as “vessel”, “drinking vessel” or “beverage vessel”) will be described in connection with a shot glass configuration.

As is described more fully below, the drinking vessel can be configured to include a wireless communication interface operatively coupled to the controller, wherein the wireless communication interface is configured to wirelessly transfer signals representative of the number of sensed events to a portable communication device.

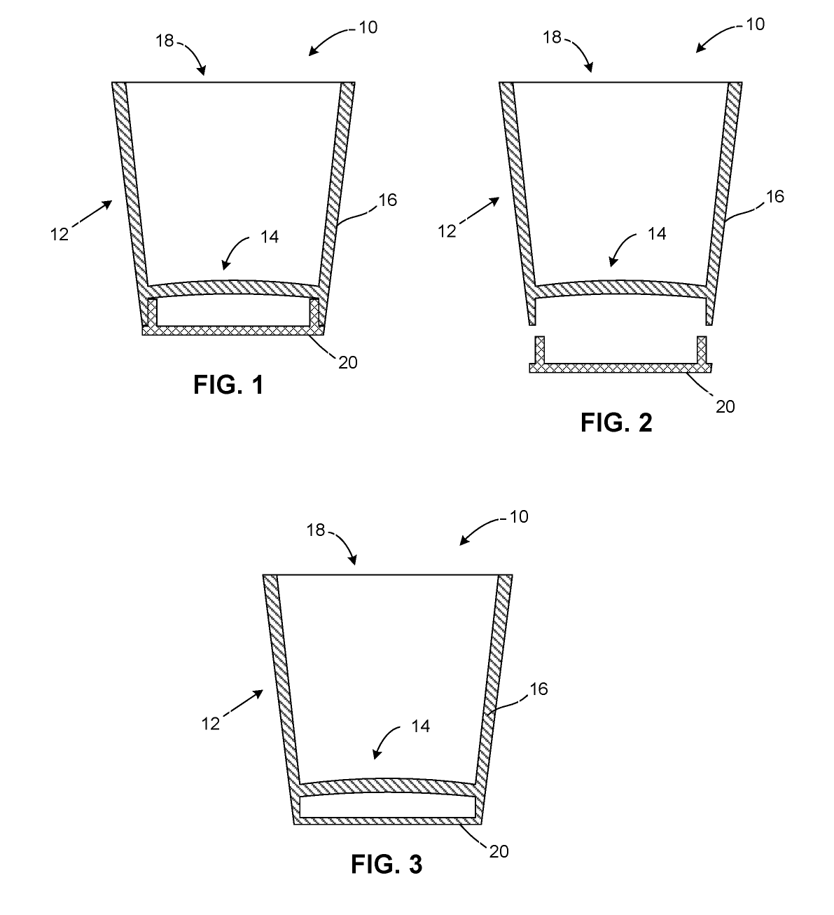

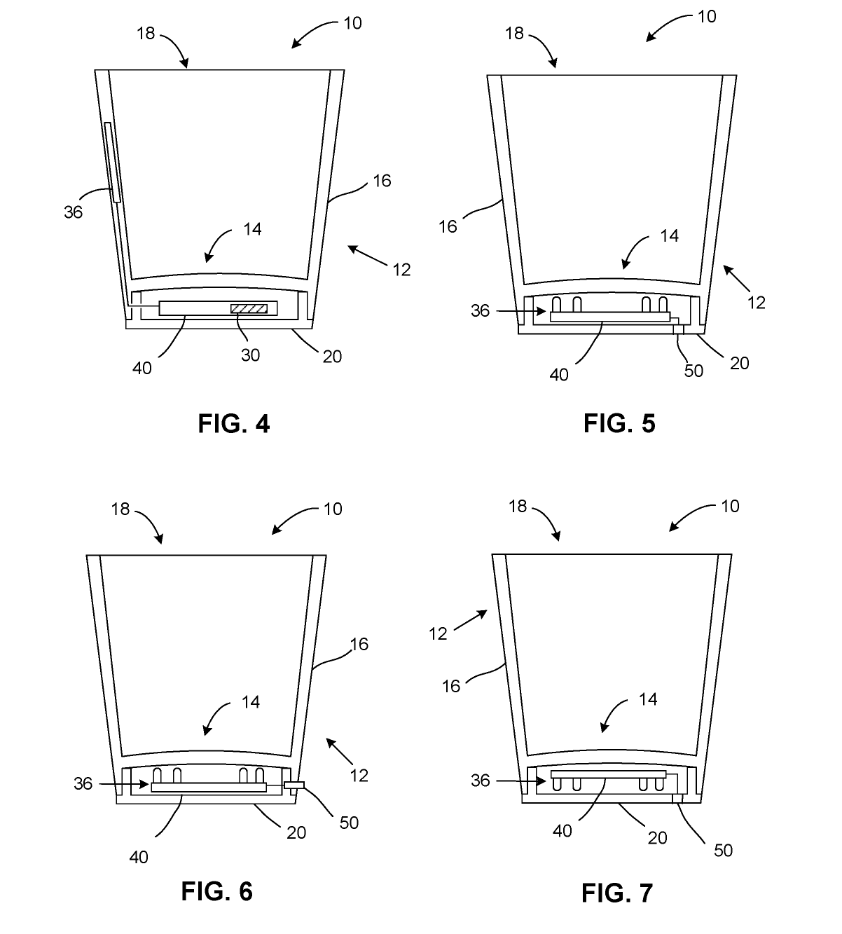

Referring now to FIGS. 1-7, a drinking vessel 10 is provided. In accordance with one aspect of the disclosed technology, the drinking vessel includes comprising a body 12 having a closed bottom portion 14 and a sidewall 16 extending from the closed bottom portion 14 and forming an open top portion 18 and a base 20 disposed below the body 12. It will be appreciated that the drinking vessel can be constructed in numerous ways out of a variety of materials without departing from the scope of the disclosed technology. For example, the drinking vessel can be formed with a hollow side wall for housing associated sensors, controllers and/or visual indicators. In a preferred embodiment, the drinking vessel will be constructed out of a plastic material suitable for the desired use of the drinking vessel.

Alternatively, the drinking vessel can be constructed where the base is coupled to the bottom portion of the body (see, e.g., FIG. 1 and FIG. 2). Alternatively, the drinking vessel can be configured such that the base is integrally formed with the bottom portion of the body (see, e.g., FIG. 3).

The drinking vessel is configured to include a sensor or sensor configuration 30. In accordance with one exemplary feature, the sensor is configured as an orientation sensor operatively coupled to a portion of the drinking vessel, where the orientation sensor is configured to determine an orientation of the drinking vessel. It will be appreciated that the orientation sensor can be positioned in various portions of the drinking vessel without departing from the scope of the disclosed technology. For example, the orientation sensor can be positioned within the base 20 or within the sidewall 16 of the drinking vessel 10 without departing from the scope of the disclosed technology.

Further, it will be appreciated that the orientation sensor can take on many forms or configurations without departing from the scope of the disclosed technology. For example, the orientation sensor can take on the form of a tilt sensor, inclinometer, gyroscope or other suitable multi-axis motion and/or orientation sensor without departing from the scope of the disclosed technology.

In accordance with one exemplary feature, the drinking vessel can also be equipped with a liquid sensor configured to detect when liquid is present in the drinking vessel in addition to or in place of the above-described orientation sensor. It will be appreciated that a number of suitable sensing technologies can be incorporated without departing from the scope of the disclosed technology. For example, the liquid sensor can take the form of a weight sensor configured to determine the weight of liquid contained with the drinking vessel. In accordance with another exemplary feature, the liquid sensor can take the form of a suitable capacitive or resistive sensor configured to determine when liquid is present within the drinking vessel.

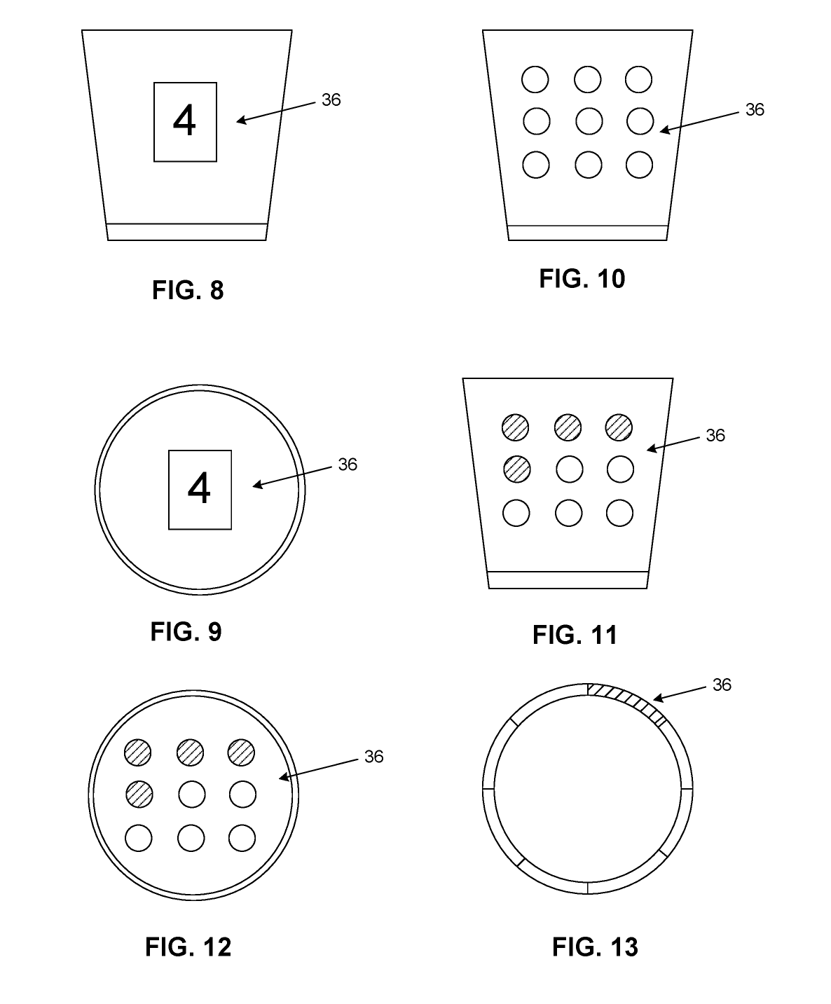

The drinking vessel is configured to include a visual indicator 36 or multiple visual indicators operatively coupled to the drinking vessel. It will be appreciated that the visual indicator can be configured in a number of ways without departing from the scope of the disclosed technology. For example, referring now to FIGS. 8-13, the drinking vessel or container further includes one or more visual indicators to provide a visual display indicative of the number of drinks consumed during a drinking session. For example, the visual indicator can be configured as a light emitting diode (LED) arrangement configured to provide a visual indication indicative or otherwise representative of a number of detected drinking events during a drinking session.

In accordance with one exemplary feature, the visual indicator is disposed within a portion of the base. In accordance with one exemplary feature, the visual indicator is positioned within the base such that the visual indicator can be viewed through a bottom portion of the base. In accordance with another exemplary feature, the visual indicator is positioned within the base such that the visual indicator can be viewed from above the drinking vessel. For example, the drinking vessel can be configured such that a portion of the base defines a space and the visual indicator is disposed within a portion of the space defined by the base. In accordance with another exemplary feature, the visual indicator is disposed within a portion of the sidewall of the body. For example, the drinking vessel can be configured such that a sidewall of the body defines a space and the visual indicator is disposed within a portion of the space defined by the sidewall of the body.

It will be appreciated that the visual indicator can take on a number of configurations without departing from the scope of the disclosed technology. For example, the visual indicator can be configured as a light emitting diode (LED) arrangement configured to provide a visual indication indicative or otherwise representative of a number of detected drinking events during a drinking session. In accordance with one exemplary feature, the visual indicator can be configured as an alphanumeric indicator (see, e.g., FIG. 8 and FIG. 9). As is described more fully below, the alphanumeric indicator can be controllable to display a number indicative of the number of counted drinking events.

In accordance with another exemplary feature, the visual indicator can be configured as a non-alphanumeric indicator (see, e.g., FIGS. 10-12). In accordance with another exemplary feature, the visual indicator is configured as or otherwise includes an electronically segmented rim associated with the upper portion of the sidewall (see, e.g., FIG. 13). In accordance with another exemplary feature, the visual indicator can be configured as or otherwise include an electronically segmented rim associated with a lower portion of the base. In accordance with another exemplary feature, the visual indicator can be configured as or otherwise include a light emitting diode indicator that is controllable to blink indicative of the number of sensed events/counted drinking events.

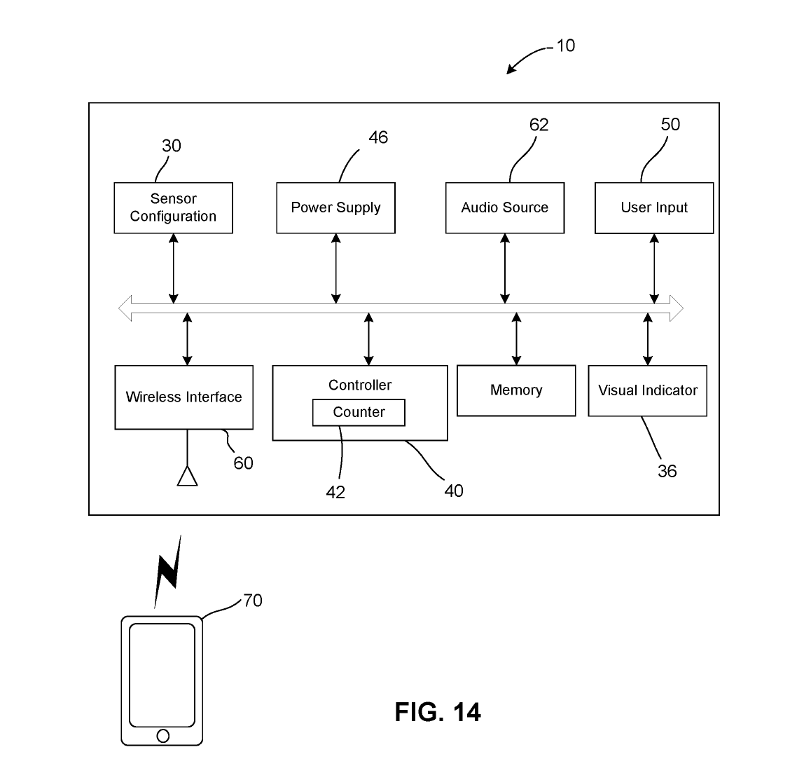

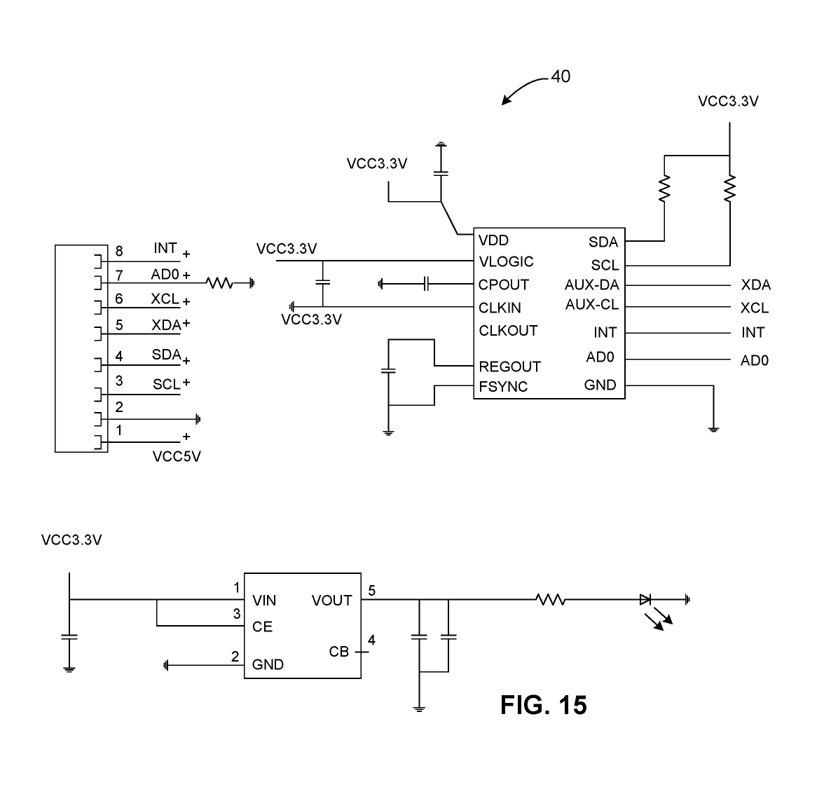

Referring now to FIG. 14 and FIG. 15, the drinking vessel 10 is configured to include a controller 40 operatively coupled to the orientation sensor (or other suitable sensor or sensor configuration 30) and the visual indicator 36. In accordance with one exemplary feature, the controller 40 is configured to receive signals from the orientation sensor indicative of a sensed orientation of the drinking vessel and determine whether the sensed orientation is greater than a predefined threshold. If the sensed orientation is greater than a predefined threshold, the controller will increment a counter 42 indicative of the number of sensed events and provide a control signal to the visual indicator 36 representative of the number of sensed events.

In accordance with another exemplary feature, the drinking vessel includes a power supply 46 operatively coupled to the controller 40, the sensor configuration 30 (e.g., orientation sensor) and the visual indicator 36. It will be appreciated that the power supply can take on any suitable form, such as a battery. In accordance with another exemplary feature, the drinking vessel can include a power switch (or other suitable user input device) 50 (see, e.g., FIGS. 5-7). The power switch 50 can be positioned in any suitable location, such as within the base 20 or lower portion of the drinking vessel.

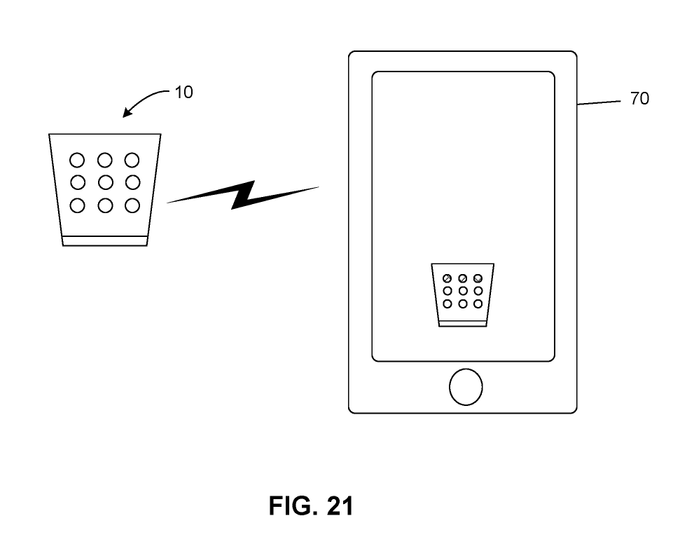

In accordance with another exemplary feature, the drinking vessel can be configured to include a wireless communication interface operatively coupled to the controller, wherein the wireless communication interface is configured to wirelessly transfer signals representative of the number of sensed events to a portable communication device (see, e.g., FIG. 14 and FIG. 21). It will be appreciated that the wireless communication interface can take on any suitable form, such as a Bluetooth module or other suitable near-field communication interface, without departing from the scope of the disclosed technology.

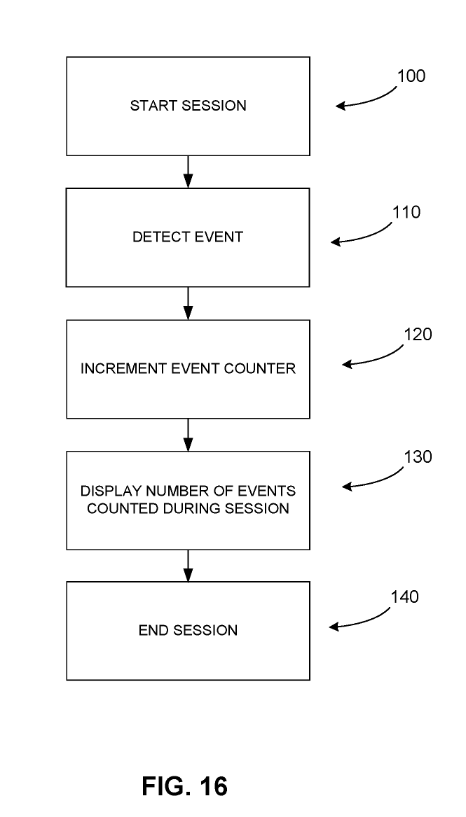

Turning now to FIGS. 16-20 and FIG. 22, methods of determining a number of drinking events during a drinking session or other time period are provided. While for purposes of simplicity of explanation, the flow charts or diagrams in FIGS. 16-20 and FIG. 22 include a series of steps or functional blocks that represent one or more aspects of the relevant operation of the drinking vessel. It is to be understood and appreciated that aspects of the disclosed technology described herein are not limited to the order of steps or functional blocks, as some steps or functional blocks may, in accordance with aspects of the present invention occur in different orders and/or concurrently with other steps or functional blocks from that shown or described herein. Moreover, not all illustrated steps or functional blocks of aspects of relevant operation may be required to implement a methodology in accordance with an aspect of the disclosed technology. Furthermore, additional steps or functional blocks representative of aspects of relevant operation may be added without departing from the scope of the disclosed technology.

It will be appreciated that one or more methods of determining a number of drinking events during a drinking session or other time period can be implemented on or otherwise using a drinking vessel according to any of the exemplary aspects discussed above. For example one or more methods of determining a number of drinking events can be implemented on or otherwise using a drinking vessel including a body having a closed bottom portion and a sidewall extending from the closed bottom portion and forming an open top portion, a base disposed below the body, an orientation sensor operatively coupled to the drinking vessel and configured to determine an orientation of the drinking vessel, and a visual indicator operatively coupled to the drinking vessel.

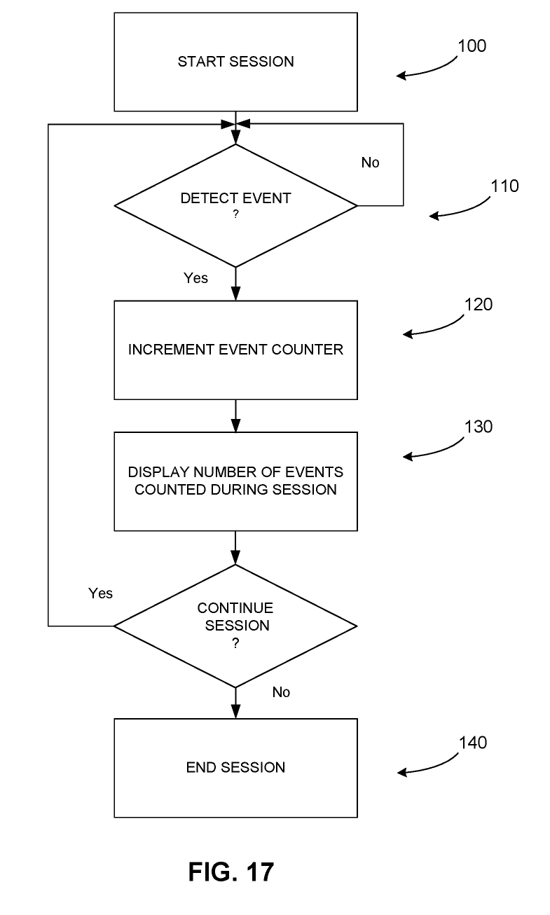

In accordance with one exemplary aspect set forth in FIG. 16 and FIG. 17, the method can include receiving user input indicative of a user starting a drinking session or other time period 100. After the drinking session has begun, the method includes the drinking vessel detecting a drinking event 110. Upon detection of a drinking event, the drinking vessel is configured to increment an event counter associated with the drinking vessel 120. The number of drinking events counted in the drinking session is then displayed by the vessel using a suitable visual indicator 130. After some period of time, user-defined or otherwise, the drinking session will be ended (140).

In accordance with one exemplary aspect, the method can include receiving an input indicative of a user starting a drinking session or other time period; receiving signals from the orientation sensor indicative of a sensed orientation of the drinking vessel; determining that a drinking event occurred based on the signals received from the orientation sensor; incrementing a counter representative of a number of drinking events during the drinking session; and providing a visual representation on the drinking vessel representative of the number of drinking events detected during the drinking session.

In accordance with one exemplary embodiment, the method includes receiving user input indicative of the beginning of a drinking session. In response to the received user input, the device or vessel begins tracking the number of drinking events during the drinking session. The number of drinking events during the drinking session can be tracked in a number of different ways without departing from the scope of the disclosed technology.

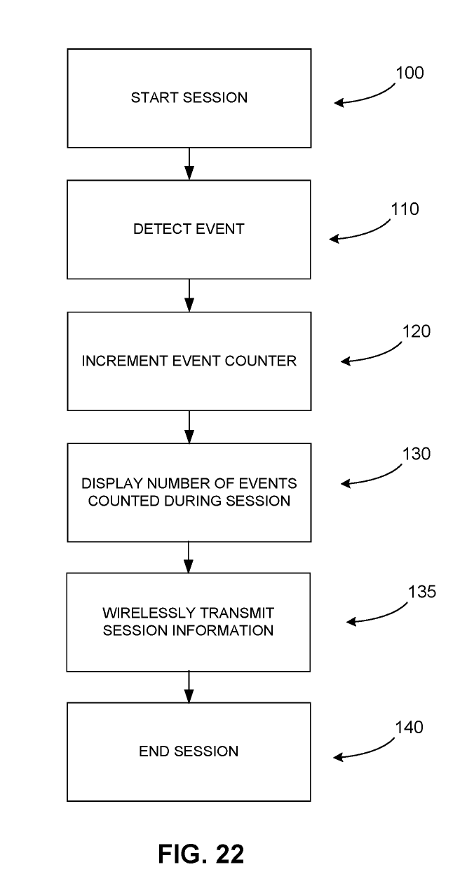

In accordance with one exemplary feature, the method can include wirelessly transmitting 135 the number of drinking events during the drinking session to a portable communication device via a wireless transmitter (see FIG. 22).

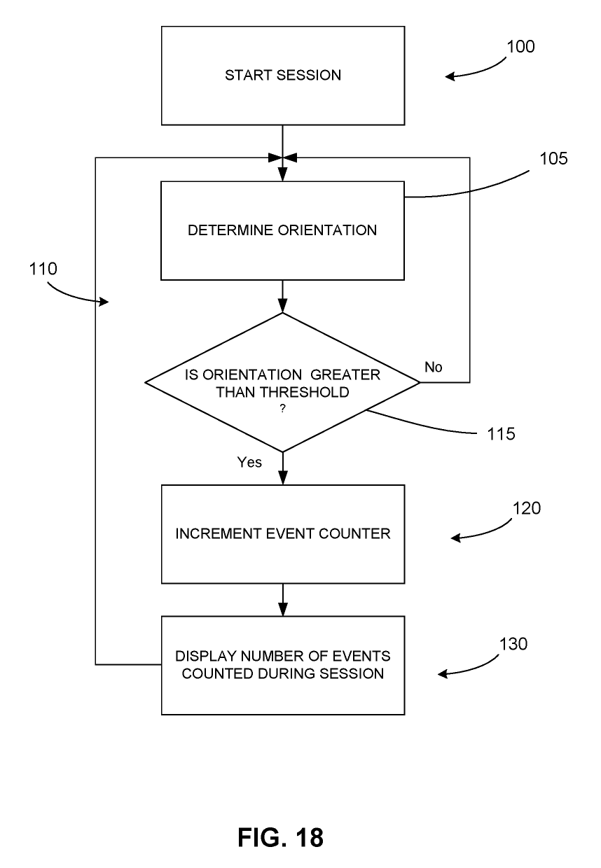

In accordance with one exemplary feature illustrated in FIG. 18, determining that a drinking event occurred 110 includes measuring or otherwise determining an orientation of the drinking vessel 105 and determining when a change in the orientation of the drinking vessel exceeds a predetermined threshold 115.

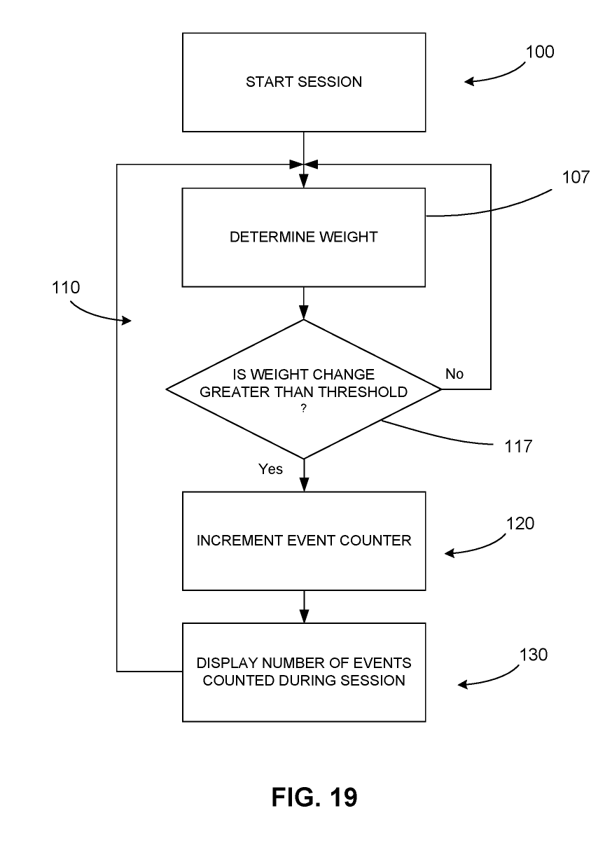

In accordance with one exemplary feature, determining that a drinking event occurred 110 includes measuring or otherwise determining the weight of the any contents of the drinking vessel 107 and determining if the weight change is greater than a predefined threshold 117 (see, e.g., FIG. 19).

In accordance with one exemplary feature, receiving an input includes detecting user actuation of a power switch operatively coupled to the drinking vessel. In accordance with another exemplary feature, receiving an input includes receiving an input indicative or the user starting a drinking session having a predetermined time period.

In accordance with one exemplary feature, the method can include providing a notification to the user indicative of an expiration of the predetermined time period. In accordance with one exemplary feature, providing a notification includes providing a notification via the visual indicator. In accordance with another exemplary feature, providing a notification includes providing a notification via an audio source 62 operatively coupled to the drinking vessel. In accordance with another exemplary feature, providing a notification can include providing a notification includes wirelessly transmitting a signal via the wireless transmitter to a portable communication device. It will be appreciated that the various notification examples can be used alone or together without departing from the scope of the disclosed technology.

In accordance with another exemplary feature, providing a visual indication via the visual indicator representative of detecting a predefined maximum number of drinking events during the drinking session.

In accordance with another aspect of the disclosed technology, a drinking vessel includes a body having a closed bottom portion and a sidewall extending from the closed bottom portion and forming an open top portion and a base disposed below the body. The drinking vessel further includes a sensor configuration operatively coupled to the drinking vessel and a visual indicator operatively coupled to the drinking vessel. A controller is operatively coupled to the sensor configuration and the visual indicator. The controller is configured to receive signals from the sensor configuration indicative of a sensed condition of the drinking vessel and determine whether the signals received from the sensor configuration are indicative of a drinking event. If the signals received from the sensor configuration are indicative of a drinking event, the controller is configured to increment a counter indicative of the number of sensed drinking events and provide a control signal to the visual indicator to display a visual indication representative of the number of sensed drinking events.

In accordance with one exemplary feature, the sensor configuration includes an orientation sensor, wherein the orientation sensor is configured to sense the orientation of the drinking vessel. In accordance with another exemplary feature, the sensor configuration includes a motion sensor, wherein the motion sensor is configured to sense the motion of the drinking vessel. In accordance with another exemplary feature, the sensor configuration includes a weight sensor, wherein the weight sensor is configured to sense the weight of liquid contained by the drinking vessel (FIG. 19).

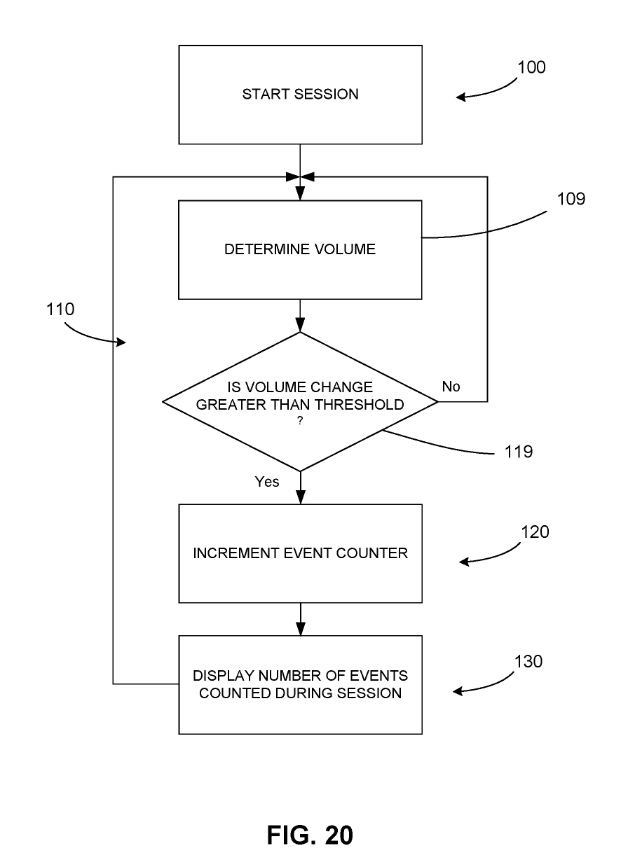

In accordance with another exemplary feature, the sensor configuration includes a liquid sensor, wherein the liquid sensor is configured to detect the presence of liquid within the drinking vessel. As shown in FIG. 20, in accordance with this exemplary feature, determining that a drinking event occurred 110 includes measuring or otherwise determining a volume of liquid within the drinking vessel 109 and determining whether the volume change is greater than a predetermined threshold 119. It will be appreciated that each of the sensor configurations can be implemented individually or together without departing from the scope of the disclosed technology.

Aspects of the disclosed technology also relate to a shot glass that includes a body defining a volume for receiving a liquid. A sensor configuration and a visual indicator are operatively coupled to the shot glass. A controller is operatively coupled to the sensor configuration and the visual indicator. The controller is configured to receive signals from the sensor configuration indicative of a sensed condition of the shot glass and determine whether the signals received from the sensor configuration are indicative of a shot of liquid being consumed from the shot glass. If the signals received from the sensor configuration are indicative of a shot of liquid being consumed from the shot glass, the controller is configured to increment a counter indicative of the number of shots being consumed from the shot glass; and provide a control signal to the visual indicator to display a visual indication representative of the number of shots being consumed from the shot glass.

It will be appreciated that various aspects of the disclosed drinking vessel or container can provide a number of advantages, including the ability for a user to more reliably monitor their consumption during a drinking session or other period of time.

While aspects of the disclosed technology have been described with respect to a drinking vessel configured as a shot glass, it will be appreciated that aspects of the disclosed technology can be implemented in connection with other drinking vessel configurations. For example, the drinking vessel can be configured as a regular drinking glass, a mug, a travel drinking container and the like.

Although the disclosed technology has been shown and described with respect to a certain preferred aspect, feature, embodiment or embodiments and features, it is obvious that equivalent alterations and modifications will occur to others skilled in the art upon the reading and understanding of this specification and the annexed drawings. In particular regard to the various functions performed by the above described elements (components, assemblies, devices, members, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary aspect, embodiment or embodiments of the disclosed technology. In addition, while a particular feature of the disclosed technology may have been described above with respect to only one or more of several illustrated aspects or embodiments, such feature may be combined with one or more other features of the other embodiments, as may be desired and advantageous for any given or particular application.

1. A drinking vessel comprising:
a body having a closed bottom portion and a sidewall extending from the closed bottom portion and forming an open top portion;
a base disposed below the body;
an orientation sensor operatively coupled to the drinking vessel and configured to determine an orientation of the drinking vessel;
a visual indicator operatively coupled to the drinking vessel;
a controller operatively coupled to the orientation sensor and the visual indicator, wherein the controller is configured to:
receive signals from the orientation sensor indicative of a sensed orientation of the drinking vessel;
determine whether the sensed orientation is greater than a predefined threshold;
if the sensed orientation is greater than a predefined threshold, increment a counter indicative of the number of sensed events;
and provide a control signal to the visual indicator representative of the number of sensed events.

2. The drinking vessel of claim 1, wherein the base is coupled to the bottom portion of the body or integrally formed with the bottom portion of the body.

3. (canceled)

4. (canceled)

5. The drinking vessel of claim 1, wherein the visual indicator is positioned within the base such that the visual indicator can be viewed through a bottom portion of the base.

6. The drinking vessel of claim 1, wherein the visual indicator is positioned within the base such that the visual indicator can be viewed from above the drinking vessel.

7. The drinking vessel of claim 1, wherein the visual indicator is disposed within a portion of the sidewall of the body.

8. The drinking vessel of claim 1, wherein the sidewall of the body defines a space and the visual indicator is disposed within a portion of the space defined by the sidewall of the body.

9. (canceled)

10. The drinking vessel of claim 1, wherein the visual indicator is a light emitting diode indicator.

11. The drinking vessel of claim 1, wherein the visual indicator is an alphanumeric indicator.

12. The drinking vessel of claim 11, wherein the alphanumeric indicator is controllable to display a number indicative of the number of counted drinking events.

13. The drinking vessel of claim 1, wherein the visual indicator is a non-alphanumeric indicator.

14. The drinking vessel of claim 13, wherein the visual indicator includes an electronically segmented rim associated with the upper portion of the sidewall.

15. The drinking vessel of claim 13, wherein the visual indicator includes an electronically segmented rim associated with a lower portion of the base.

16. The drinking vessel of claim 10, wherein the light emitting diode indicator is controllable to blink indicative of the number of sensed events/counted drinking events.

17. The drinking vessel of claim 1, wherein the drinking vessel is configured as a shot glass.

18. The drinking vessel of claim 1, wherein the orientation sensor is a gyroscope.

19. The drinking vessel of claim 1, further comprising a power supply operatively coupled to the controller, the orientation sensor and the visual indicator.

20. (canceled)

21. The drinking vessel of any of claim 1, further comprising a power switch.

22. (canceled)

23. The drinking vessel of claim 1, further comprising a wireless communication interface operatively coupled to the controller, wherein the wireless communication interface is configured to wirelessly transfer signals representative of the number of sensed events to a portable communication device.

24. (canceled)

25. A method of determining a number of drinking events during a drinking session using a drinking vessel including a body having a closed bottom portion and a sidewall extending from the closed bottom portion and forming an open top portion, a base disposed below the body, an orientation sensor operatively coupled to the drinking vessel and configured to determine an orientation of the drinking vessel, and a visual indicator operatively coupled to the drinking vessel, the method comprising:
receiving an input indicative of a user starting a drinking session;
receiving signals from the orientation sensor indicative of a sensed orientation of the drinking vessel;
determining that a drinking event occurred based on the signals received from the orientation sensor;
incrementing a counter representative of a number of drinking events during the drinking session; and
providing a visual representation on the drinking vessel representative of the number of drinking events detected during the drinking session.

26. The method of claim 25, further comprising:
wirelessly transmitting the number of drinking events during the drinking session to a portable communication device via a wireless transmitter.

27. The method of claim 25, wherein determining that a drinking event occurred includes measuring an orientation of the drinking vessel and determining when a change in the orientation of the drinking vessel exceeds a predetermined threshold.

28. (canceled)

29. The method of claim 25, wherein receiving an input includes receiving an input indicative or the user starting a drinking session having a predetermined time period.

30. The method of claim 29, further comprising providing a notification to the user indicative of an expiration of the predetermined time period.

31. The method of claim 30, wherein providing a notification includes:
providing a notification via the visual indicator
providing a notification via an audio device operatively coupled to the drinking vessel; and/or
providing a notification includes wirelessly transmitting a signal via the wireless transmitter to a portable communication device.

32. (canceled)

33. (canceled)

34. The method of claim 25, further comprising providing a visual indication via the visual indicator representative of detecting a predefined maximum number of drinking events during the drinking session.

35. A drinking vessel comprising:
a body having a closed bottom portion and a sidewall extending from the closed bottom portion and forming an open top portion;
a base disposed below the body;
a sensor configuration operatively coupled to the drinking vessel;
a visual indicator operatively coupled to the drinking vessel;
a controller operatively coupled to the sensor configuration and the visual indicator, wherein the controller is configured to:
receive signals from the sensor configuration indicative of a sensed condition of the drinking vessel;
determine whether the signals received from the sensor configuration are indicative of a drinking event;
if the signals received from the sensor configuration are indicative of a drinking event, increment a counter indicative of the number of sensed drinking events; and
provide a control signal to the visual indicator to display a visual indication representative of the number of sensed drinking events.

36. The drinking vessel of claim 35, wherein the sensor configuration includes an orientation sensor, wherein the orientation sensor is configured to sense the orientation of the drinking vessel.

37. The drinking vessel of claim 35, wherein the sensor configuration includes a motion sensor, wherein the motion sensor is configured to sense the motion of the drinking vessel.

38.-40. (canceled)
